(19) United States
(12) Patent Application Publication
(10) Pub. No.: US 2003/0068928 A1
(43) Pub. Date: Apr. 10, 2003

(54) Power adapter interfacing between vehicular electrical device and commercial power source

(76) Inventor: Ming-Chung Lin, Keelung (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/005,400

(22) Filed: Dec. 5, 2001

(30) Foreign Application Priority Data
Oct. 5, 2001 (TW) 090124605

(51) Int. Cl. H01R 25/00

(52) U.S. Cl. 439/638

(57) ABSTRACT

A power adapter interfacing between a vehicular electrical device and a commercial power source is disclosed. The power adapter includes a housing, an electric socket arranged on a first surface of the housing for detachably receiving thereinto the plug of the vehicular electrical device, an electric plug arranged on a second surface of the housing for detachably plugging into a socket of the commercial power source, and an adapter circuit arranged in the housing and electrically connected between the electric socket and the electric plug for converting a commercial power specification into a vehicular power specification and providing the resulting power for the vehicular electrical device. This power adapter allows a vehicular electrical device conventionally adapted for a vehicular power source only to be used both inside and outside a vehicle without modifying the vehicular electrical device.

### FIELD OF THE INVENTION

The present invention relates to a power adapter, and more particularly to a power adapter for providing commercial electric power for a vehicular electrical device.

### BACKGROUND OF THE INVENTION

Electrical devices suitable for use in a vehicle are more and more popular. The power specification of the vehicular electrical devices should comply with the requirement of a vehicular power source. For example, vehicular power is typically around a voltage of 12 volts and direct current, so the vehicular electrical devices are designed for use under such conditions. In other words, the vehicular electrical devices are not adapted to be used under commercial AC power that is of a much larger voltage than the vehicular DC power.

A variety of vehicular electrical devices, however, are sometimes necessarily used at home or office where no small power voltage is available. A cellular phone charger or handsfree car kit, as shown in FIG. 1, is one of the examples for frequent use both inside and outside a car. The vehicular charger includes a plug 11 and a base station 12. When the cellular phone is attached to the base station 12, and the plug 11 is electrically connected to the cigarette lighter adapter of the car (not shown), the cellular phone will receive vehicular power via the vehicular charger. Owing to the mismatching power specifications between the vehicular and commercial power supplies, two sets of cellular phone chargers or handsfree car kits of different power specifications are conventionally required.

### SUMMARY OF THE INVENTION

Therefore, an object of the present invention is to provide a power adapter, which converts the commercial power specification into a vehicular power specification, thereby allowing a vehicular electrical device to be used under both commercial and vehicular power source.

A first aspect of the present invention relates to a power adapter for use with a vehicular electrical device. The vehicular electrical device includes a plug for receiving power from a vehicular power source, and the power adapter includes a housing; an electric socket arranged on a first surface of the housing for detachably receiving thereinto the plug of the vehicular electrical device; an electric plug arranged on a second surface of the housing for detachably plugging into a socket of a commercial power source; and an adapter circuit arranged in the housing and electrically connected between the electric socket and the electric plug for converting a commercial power specification into a vehicular power specification and providing the resulting power for the vehicular electrical device.

Preferably, the first surface is different from the second surface, and more preferably, the first and second surfaces are adjacent and perpendicular to each other.

In an embodiment, the adapter circuit is implemented on a circuit board. The circuit board is preferably mounted on an inner surface of the housing via a plurality of supporting posts so that elements of the adapter circuit can be mounted on the circuit board within a space confined by the supporting posts, thereby making the adapter compact.

A second aspect of the present invention relates to a power adapter for use with a vehicular electrical device, which includes a housing; a first connector arranged on a first surface of the housing for detachably electrically connecting to the vehicular electrical device; a second connector arranged on a second surface of the housing for detachably electrically connecting to a power supply; and an adapter circuit arranged in the housing and electrically connected between the first and second connectors for converting a specification of the power supply into a specification of the vehicular power source, and providing a vehicular power for the vehicular electrical device.

In an embodiment, the first connector is an electric socket to be electrically connected to a plug of the vehicular electrical device, and the second connector is an electric plug to be electrically connected to a socket of the power supply.

In general, the power supply is of a voltage larger than a voltage of the vehicular power source. For example, the vehicular power source is of a direct-current (DC) type, and the power supply is a commercial alternate-current (AC) power source.

### BRIEF DESCRIPTION OF THE DRAWINGS

The present invention may best be understood through the following description with reference to the accompanying drawings, in which:

FIG. 1 is a schematic diagram showing a typical vehicular charger of a cellular phone;

FIG. 2 is a schematic diagram showing a preferred embodiment of a power adapter according to the present invention;

FIG. 3 is a schematic block diagram illustrating the use of a power adapter according to the present invention;

FIG. 4 is a schematic diagram showing an embodiment of the arrangement of the power adapter according to the present invention; and

FIG. 5 is a circuit block diagram showing an embodiment of the adapter circuit of the power adapter according to the present invention.

### DETAILED DESCRIPTION OF THE PREFERRED EMBODIMENT

The present invention will now be described more Specifically with reference to the following embodiments. It is to be noted that the following descriptions of preferred embodiments of this invention are presented herein for purpose of illustration and description only; it is not intended to be exhaustive or to be limited to the precise form disclosed.

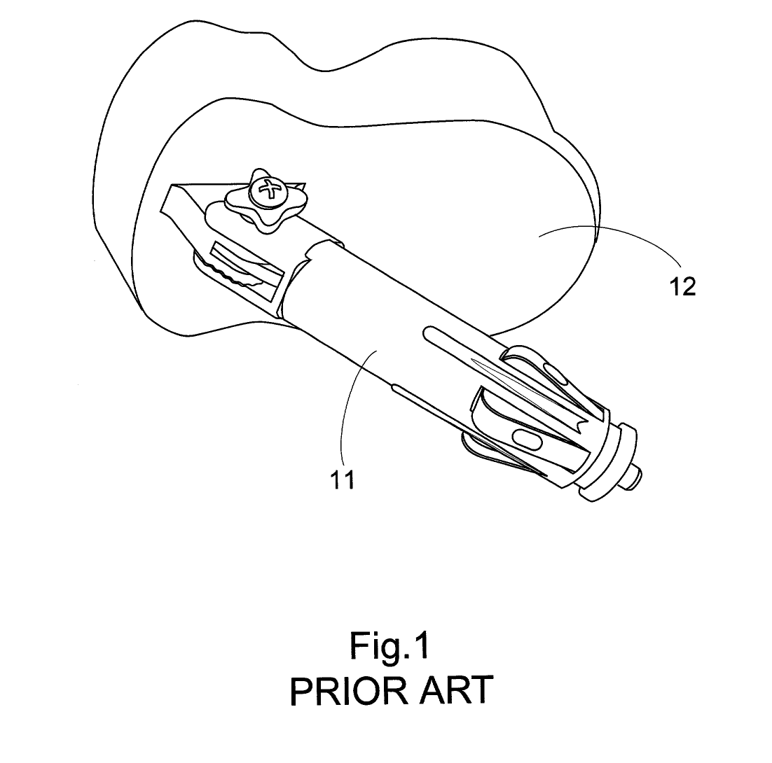

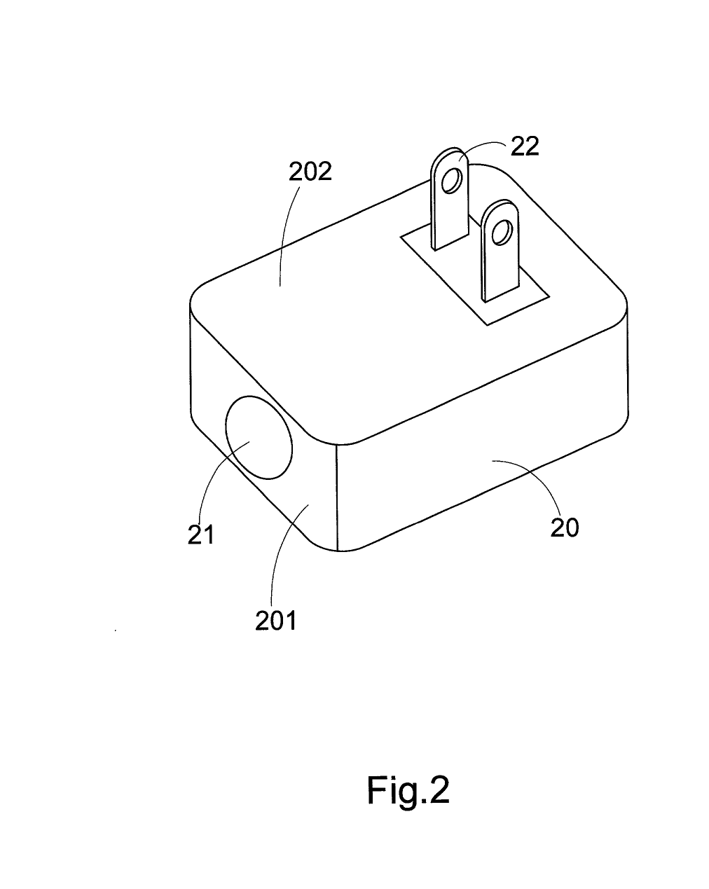

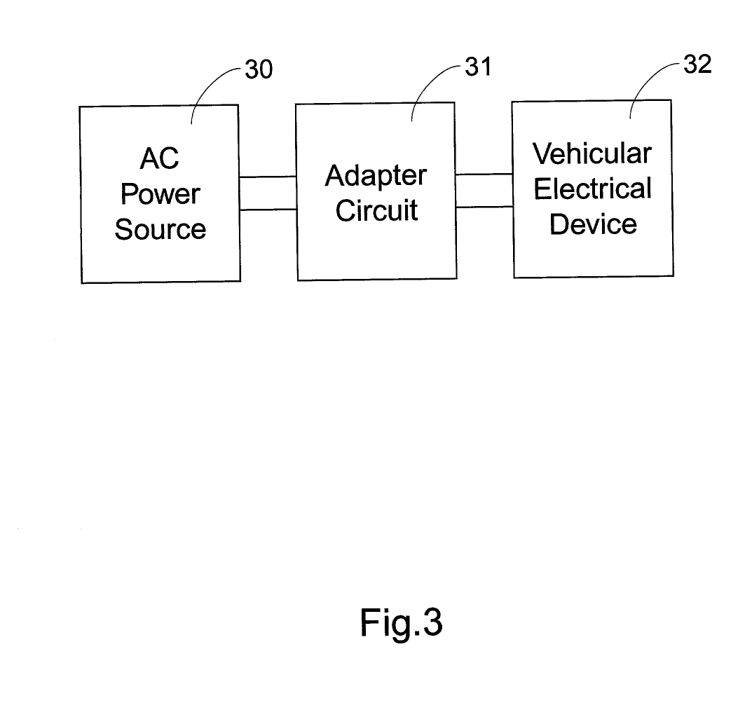

Please refer to FIG. 2 which is a schematic diagram showing a preferred embodiment of a power adapter according to the present invention. The power adapter includes an electric socket 21 and an electric plug 22 on two adjacent and perpendicular surfaces 201 and 202 of the housing 20, respectively. The vehicular charger of a cellular phone as shown in FIG. 1 conventionally receives DC power from a vehicular source via a cigarette lighter adapter of the car. When the cellular phone is to be used outside the car, e.g. at office, the same vehicular charger is detached from the cigarette lighter adapter, and brought to the office. By plugging the electric plug 22 of the present power adapter into the socket (not shown) of the commercial power source directly or indirectly, e.g. via an uninterrupted power supply, and plugging the plug 11 of the vehicular charger into the electric socket 21 of the present power adapter, referring to FIG. 3, the vehicular charger 32 can receive usable power from the commercial AC power source 30 via the adapter circuit 31 of the power adapter. The structural and circuitry embodiments of the power adapter will be illustrated hereinafter.

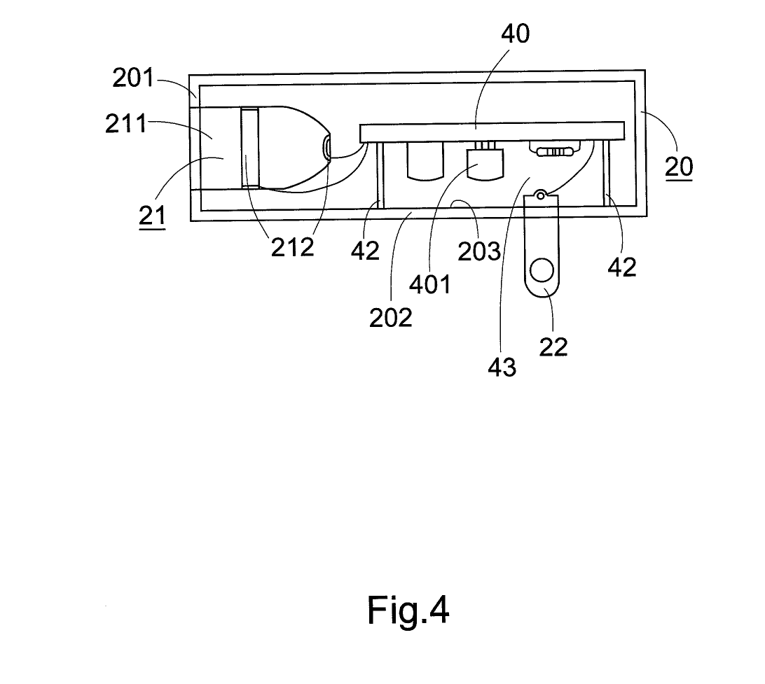

Please refer to FIG. 4 which is a schematic diagram showing an embodiment of the arrangement of the power adapter according to the present invention. The electric socket 21 of the power adapter includes an electrically conductive plate 212 mounted in a socket hole 211 for electric contact with the plug of the vehicular electrical device. Further, a circuit board 40 welded thereon required electronic elements 401 which performs the function of the adapter circuit 31. The circuit board 40 is mounted on an inner surface 203 of the housing 20 via a plurality of supporting posts 42. By propping up the circuit board 40, a space 43 confined by the supporting posts 42, the circuit board 40 and the housing wall 202 is provided for the accommodation of the electronic elements 401. The space 43 is also provided for receiving a part of the protruding plug 22 for connecting to the non-vehicular power supply. Such arrangement results in a compact design of the power adapter.

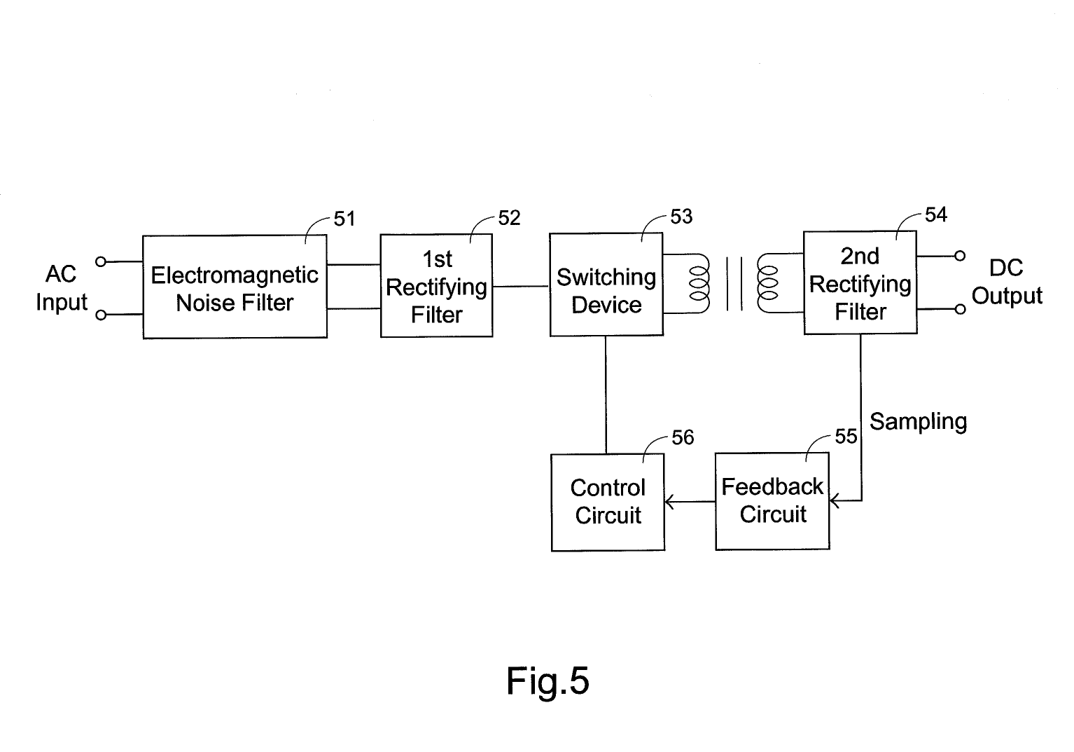

Now please refer to FIG. 5 which is a circuit block diagram showing an embodiment of the adapter circuit of the power adapter according to the present invention. The high-voltage input AC power is processed by an electromagnetic noise filter 51, a first rectifying filter 52, a switching device 53 and a second rectifying 54 to be outputted as a low-voltage DC power. A feedback circuit 55 is provided for dynamically informing the switching device 53 of the status of the output end, e.g. current intensity of voltage level, so that the operational state of the circuit is adjusted with the variation of the load under the control of a control circuit 56. Preferably, the operational voltage of the power adapter can be switched between at least two different levels, e.g. 110/220 volts, thereby making the use of the present power adapter more flexible.

It is to be noted that the present invention is illustrated by giving a cellular phone charger as an example. The present invention can be applied to any other vehicular electrical device such as a vehicular lamp, a vehicular fan, a vehicular speaker or a vehicular LCD display when the vehicular electrical device is to be used in a location other than the vehicle.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power adapter for use with a vehicular electrical device, said vehicular electrical device including a plug for receiving power from a vehicular power source, and said power adapter comprising:
a housing;
an electric socket arranged on a first surface of said housing for detachably receiving thereinto said plug of said vehicular electrical device;
an electric plug arranged on a second surface of said housing for detachably plugging into a socket of a commercial power source; and
an adapter circuit arranged in said housing and electrically connected between said electric socket and said electric plug for converting a commercial power specification into a vehicular power specification and providing the resulting power for said vehicular electrical device.

2. The power adapter according to claim 1 wherein said first surface is different from said second surface.

3. The power adapter according to claim 1 wherein said adapter circuit is implemented on a circuit board.

4. The power adapter according to claim 3 wherein said circuit board is mounted on an inner surface of said housing via a plurality of supporting posts.

5. The power adapter according to claim 4 wherein elements of said adapter circuit are mounted on said circuit board within a space confined by said supporting posts and facing to said inner surface of said housing.

6. A power adapter for use with a vehicular electrical device, comprising:
a housing;
a first connector arranged on a first surface of said housing for detachably electrically connecting to said vehicular electrical device;
a second connector arranged on a second surface of said housing for detachably electrically connecting to a power supply; and
an adapter circuit arranged in said housing and electrically connected between said first and second connectors for converting a specification of said power supply into a specification of said vehicular power source, and providing a vehicular power for said vehicular electrical device.

7. The power adapter according to claim 6 wherein said first connector is an electric socket to be electrically connected to a plug of said vehicular electrical device.

8. The power adapter according to claim 6 wherein said second connector is an electric plug to be electrically connected to a socket of said power supply.

9. The power adapter according to claim 6 wherein said power supply is of a voltage larger than a voltage of said vehicular power source.

10. The power adapter according to claim 9 wherein said vehicular power source is of a direct-current (DC) type, and said power supply is a commercial alternate-current (AC) power source.

11. The power adapter according to claim 6 wherein said adapter circuit is implemented on a circuit board.

12. The power adapter according to claim 11 wherein said circuit board is mounted on an inner surface of said housing via a plurality of supporting posts.

13. The power adapter according to claim 12 wherein elements of said adapter circuit are mounted on said circuit board within a space confined by said supporting posts and facing to said inner surface of said housing.
